(19) United States
(12) Patent Application Publication
(10) Pub. No.: US 2008/0220644 A1
(43) Pub. Date: Sep. 11, 2008

(54) CONNECTOR

(75) Inventors: SHINJI YAMADA, Kanagawa (JP); TOMOYA IWASA, Kanagawa (JP)

Correspondence Address: MCCORMICK, PAULDING & HUBER LLP, CITY PLACE II, 185 ASYLUM STREET, HARTFORD, CT, 06103, US

(73) Assignee: KYOCERA ELCO CORPORATION, Kanagawa (JP)

(21) Appl. No.: 12/043,178

(22) Filed: Mar. 6, 2008

(30) Foreign Application Priority Data
Mar. 9, 2007 (JP) 2007-59880

(51) Int. Cl. H01R 13/627

(52) U.S. Cl. 439/352

(57) ABSTRACT

A connector includes an electrical insulator made of an insulating material; a plurality of contacts fixed to the electrical insulator aligned in one direction, each contact including a contacting arm which can be in electrically continuous conduction with one of front and rear surfaces of a connection target; and a base portion from which the contacting arm extends to support the contacting arm; and an actuator which presses against the other of the front and rear surfaces of the connection target. At least one of the contacts includes a holding arm which extends from the base portion in a direction substantially parallel to the contacting arm to press the actuator toward the connection target. One of a through-hole and a cutout portion is formed in at least one of the contacts through the base portion thereof in a thickness direction thereof.

### CROSS REFERENCE TO RELATED APPLICATION

The present invention is related to and claims priority of the following co-pending application, namely, Japanese Patent Application No. 2007-59880 filed on Mar. 9, 2007.

### BACKGROUND OF THE INVENTION

1. Field of the Invention

The present invention relates to a connector for electrically connecting connection targets to each other such as a circuit board and a flexible printed wiring board (flexible PWB).

2. Description of the Prior Art

The connector for flexible PWB which is disclosed in Japanese unexamined patent publication 2006-310194 is provided with an electrical insulator, a plurality of tuning-fork-shaped contacts (conductive terminals) 12 and an actuator 13. The electrical insulator is made of an insulating material and has an opening on the front of the electrical insulator. The plurality of contacts 12 are fixed to the electrical insulator to be arranged inside the electrical insulator at intervals. The lower end of the actuator 13 is pivoted on the electrical insulator so that the actuator 13 is rotatable relative to the electrical insulator.

All the contacts 12 of the connector are made to the same specifications (i.e., the same type), and each contact 12 is provided with a contacting portion (contacting arm) 12b, a resilient support portion (holding arm) 12d and a base portion (no reference numeral). The contacting portion 12b is shaped into an arm which is in contact with an associated conductive portion formed on a bottom surface of a flexible PWB, the resilient support portion 12d is also shaped into an arm which is positioned directly above the contacting portion 12b, and the base portion supports base end portions of the contacting portion 12b and the resilient support portion 12d.

The bottom end surface of the actuator 13 is supported by a bottom surface (contacting surface 11c) of the electrical insulator while a top surface of a pivot 13a provided at a lower end of the actuator 13 is engaged in a recess formed on the lower surface of an end (free end) of the resilient support portion 12d so that the actuator 13 becomes rotatable relative to the electrical insulator.

In this connector, when the actuator is in the open position, even if a flexible PWB is inserted in between the resilient support portion 12d and the contacting portion 12b of each contact 12 through the aforementioned opening of the electrical insulator, the state of contact between the contacting portion 12b of each contact 12 and an associated conductive portion formed on the bottom surface of the flexible PWB is uncertain, so that continuity is not established between each contacting portion 12b and the flexible PWB. However, once the actuator is rotated to the closed position, the flexible PWB is pressed downward by the actuator, and this downward pressure against the flexible PWB causes each contacting portion 12b and the associated conductive portion on the bottom surface of the flexible PWB to come in contact with each other securely; consequently, continuity is established between each contacting portion 12b and the associated conductive portion of the flexible PWB.

High-speed-transmission connectors have been in increasing demand in recent years. Additionally, connectors are required to have the capability of suppressing an impedance mismatch which occurs between an onboard device (circuit board) and a flexible PWB inserted into a connector.

The capacitance component needs to be reduced to achieve high-speed-transmission-capable connectors. Moreover, the capacitance component which triggers crosstalk needs to be reduced to make adequate use of the impedance matching capability as well. To this end, it is ideal if the base portion of each contact, which is relatively large in area among the elements of each contact and becomes a primary factor which increases the capacitance component, is eliminated.

However, the base portion of each contact cannot be eliminated because the base portion supports the contacting portion 12b and the resilient support portion 12d (the base portions thereof) and also because the base portion of each contact is a portion necessary to receive and disperse the stress caused upon the resilient support portion 12d being resiliently deformed.

### SUMMARY OF THE INVENTION

The present invention provides a connector which makes a high-speed transmission possible and is capable of finely suppressing an impedance mismatch even though each contact includes a base portion which supports base portions of the contacting arm and the holding arm of the contact.

According to an aspect of the present invention, a connector is provided, including an electrical insulator made of an insulating material; a plurality of contacts fixed to the electrical insulator aligned in one direction, each of the plurality of contacts including a contacting arm which can be in electrically continuous conduction with one of front and rear surfaces of a connection target, and a base portion from which the contacting arm extends to support the contacting arm; and an actuator which presses against the other of the front and rear surfaces of the connection target. At least one of the plurality of contacts includes a holding arm which extends from the base portion in a direction substantially parallel to the contacting arm to press the actuator toward the connection target. One of a through-hole and a cutout portion is formed in at least one of the plurality of contacts through the base portion thereof in a thickness direction thereof.

According to the present invention, even if the connector is slimmed and miniaturized, adequate workability of inserting and removing the connection target into and from the connector and locking the connection target is achieved since the connector includes the actuator and the holding arm. Moreover, since a through-hole or a cutout portion which extends through the base portion in the direction of thickness thereof is formed in at least one of the plurality of contacts, a reduction in area of opposed surfaces of adjacent contacts of the connector in the direction in which the contacts are arranged is achieved, and accordingly, a reduction in capacitance component of each contact is achieved.

It is desirable for the one of the through-hole and the cutout portion to be formed through at least one of the plurality of contacts which is used as a signal transmission line.

It is desirable for the actuator to be rotatable relative to the electrical insulator, wherein the actuator includes at least one held portion, and the actuator is rotatable about the held portion with the holding arm pressing against the held portion toward the connection target. Accordingly, a stable rotation of the actuator is achieved since the holding arm of at least one contact presses the held portion of the actuator from above.

It is desirable for the plurality of contacts to include a plurality of ground contacts, and a plurality of signal contacts fixed to the electrical insulator and positioned in between the plurality of ground contacts.

Among the plurality of ground contacts and the plurality of signal contacts, it is desirable for only each of the ground contacts to include the holding arm. Accordingly, since each signal contact includes the contacting arm but does not include the holding arm, capacitance and inductance components can be reduced by a larger amount than in the case where not only each ground contact but also each signal contact includes the holding arm. Therefore, the connector can deliver a more excellent impedance matching capability; moreover, a higher-speed transmission is achieved.

In the case where each signal contact includes an arm corresponding to the holding arm, the connector may be influenced by external perturbations such as noise and induction due to the existence of the arm. However, the connector according to the present invention is not easily influenced by external perturbations because the connector does not include such an arm.

Additionally, the operation of the actuator can be stabilized by the ground contacts since each ground contact includes not only the contacting arm but also the holding arm so that the holding arm of each ground contact presses the actuator toward the connection target.

It is desirable for a pair of the signal contacts to be positioned between two of the ground contacts. It is desirable for the plurality of ground contacts and the plurality of signal contacts to be alternately arranged in the one direction. Accordingly, the degree of freedom in arrangement of the signal contacts can be increased with respect to transmission methods such as differential signaling and single-ended signaling.

It is desirable for the plurality of contacts to be of the same kind each of which includes the holding arm.

Therefore, in either case where the plurality of contacts are composed of two different kinds of contacts or the same kind, the connector can achieve an excellent impedance matching capability in comparison with a conventional connector having no through-hole or cutout portion in the base portion of each contact; moreover, the connector makes high-speed transmission possible. In addition, similar effects are obtained also in the case where the through-hole or the cutout portion is formed through at least one of the plurality of contacts which is used as a signal transmission line.

Additionally, making a simple change to the size and the position, etc., of the through-hole or the cutout portion makes it easy to adjust the impedance, which varies due to various factors such as signal frequency and the distance between contacts, and to optimize impedance matching.

It is desirable for the connection target to be an flexible PWB.

It is desirable for the actuator to be an elongated member which is elongated in the one direction.

It is desirable for the actuator to include a pair of pivots fixed at opposite ends of the elongated member in the above-mentioned one direction to be capable of rotating about the pair of pivots relative to the electrical insulator.

In an embodiment, a connector is provided, including a contact holder made of an electrical insulating material; a plurality of contacts fixed to the contact holder aligned in one direction, wherein each of the plurality of contacts includes a base portion and a contacting arm which extends from the base portion; and an actuator which is moved relative to the contact holder to press one of front and rear surfaces of a connection target toward the contacting arm so that the other of the front and rear surfaces of the connection target is pressed against the contacting arm to be electrically connected therewith. At least one of the plurality of contacts includes a holding arm which extends from the base portion in a direction substantially parallel to the contacting arm to press the actuator toward the connection target. One of a through-hole and a cutout portion is formed in at least one of the plurality of contacts through the base portion thereof in a thickness direction thereof.

### BRIEF DESCRIPTION OF THE DRAWINGS

The present invention will be discussed below in detail with reference to the accompanying drawings, in which:

FIG. 1 is a front perspective view of a first embodiment of a connector according to the present invention when the actuator of the connector is in the closed position;

FIG. 2 is a front perspective view of the first embodiment of the connector when the actuator of the connector is in the open position;

FIG. 3 is a rear perspective view of the first embodiment of the connector when the actuator of the connector is in the closed position;

FIG. 4 is an exploded front perspective view of the first embodiment of the connector;

FIG. 5 is an exploded rear perspective view of the first embodiment of the connector;

FIG. 6 is a front perspective view of a ground contact which serves as an element of the first embodiment of the connector;

FIG. 7 is a front perspective view of a signal contact which serves as an element of the first embodiment of the connector;

FIG. 8 is a front view of the first embodiment of the connector when the actuator of the connector is in the open position;

FIG. 9 is a plan view of the first embodiment of the connector when the actuator of the connector is in the open position;

FIG. 10 is a front view of the first embodiment of the connector when the actuator of the connector is in the closed position;

FIG. 11 is a plan view of the first embodiment of the connector when the actuator of the connector is in the closed position;

FIG. 12 is a cross sectional view taken along the XII-XII line shown in FIG. 8, viewed in the direction of the appended arrows;

FIG. 13 is a cross sectional view taken along the XIII-XIII line shown in FIG. 8, viewed in the direction of the appended arrows;

FIG. 14 is a cross sectional view taken along the XIV-XIV line shown in FIG. 10, viewed in the direction of the appended arrows;

FIG. 15 is a cross sectional view taken along the XV-XV line shown in FIG. 10, viewed in the direction of the appended arrows;

FIG. 16 is a front perspective view of a second embodiment of the connector according to the present invention when the actuator of the connector is in the closed position;

FIG. 17 is a rear perspective view of the second embodiment of the connector when the actuator of the connector is in the open position;

FIG. 18 is an exploded rear perspective view of the second embodiment of the connector;

FIG. 19 is a side view of a contact which serves as an element of the second embodiment of the connector;

FIG. 20 is a cross sectional view, similar to that of FIG. 12, of the second embodiment of the connector;

FIG. 21 is a cross sectional view of a modified embodiment of the first embodiment of the connector, taken along a line corresponding to XII-XII line shown in FIG. 8;

FIG. 22 is a cross sectional view of the embodiment of the connector shown in FIG. 21, taken along a line corresponding to XIII-XIII line shown in FIG. 8; and

FIG. 23 is a cross sectional view, similar to that of FIG. 21, of a modified embodiment of the second embodiment of the connector.

### DESCRIPTION OF THE PREFERRED EMBODIMENTS

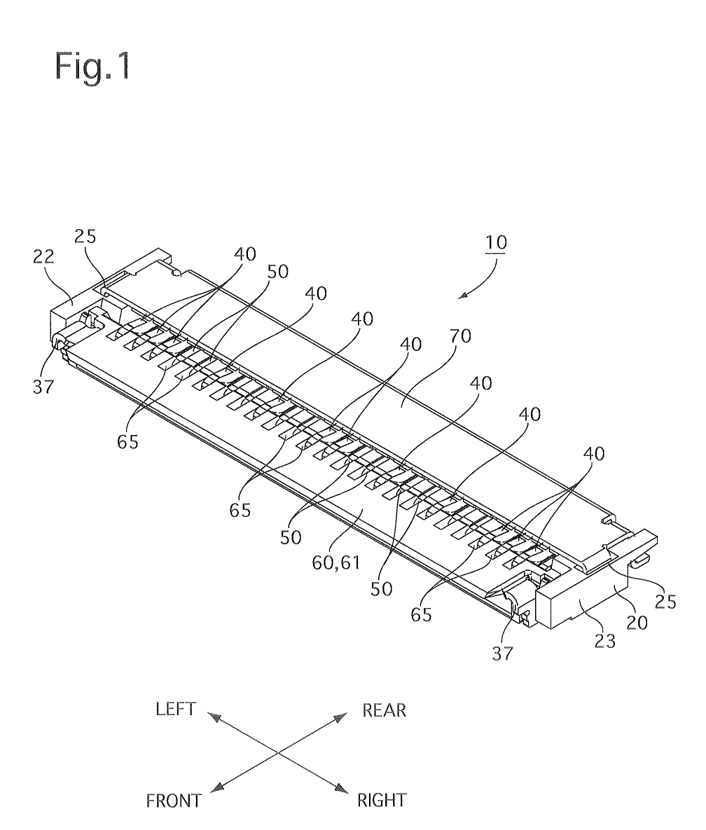

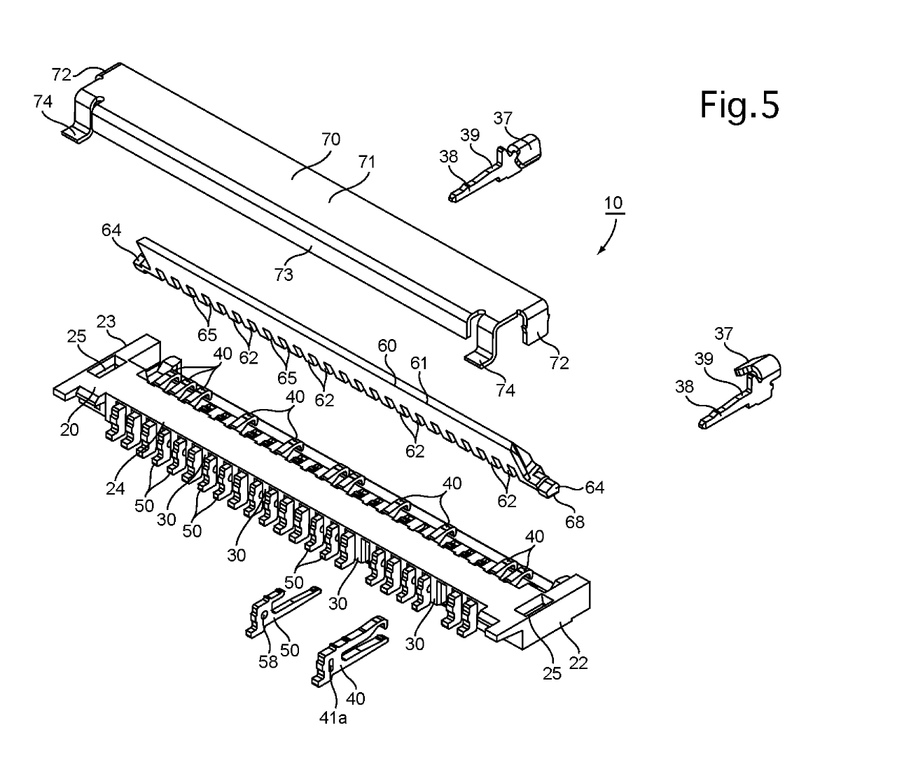

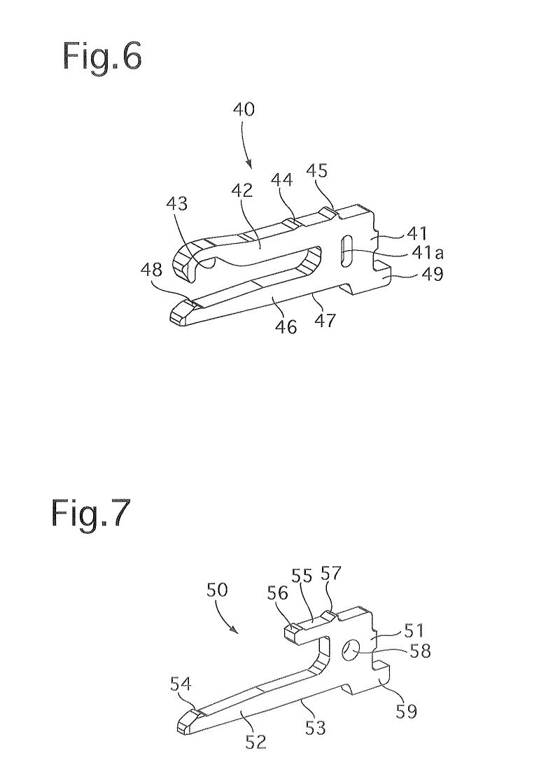

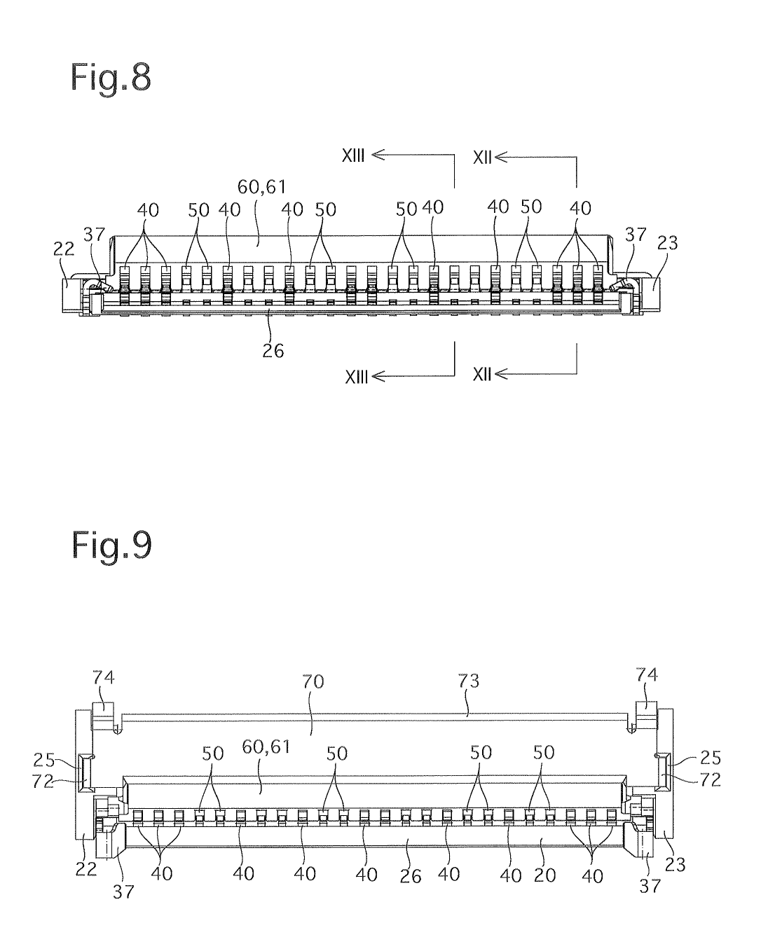

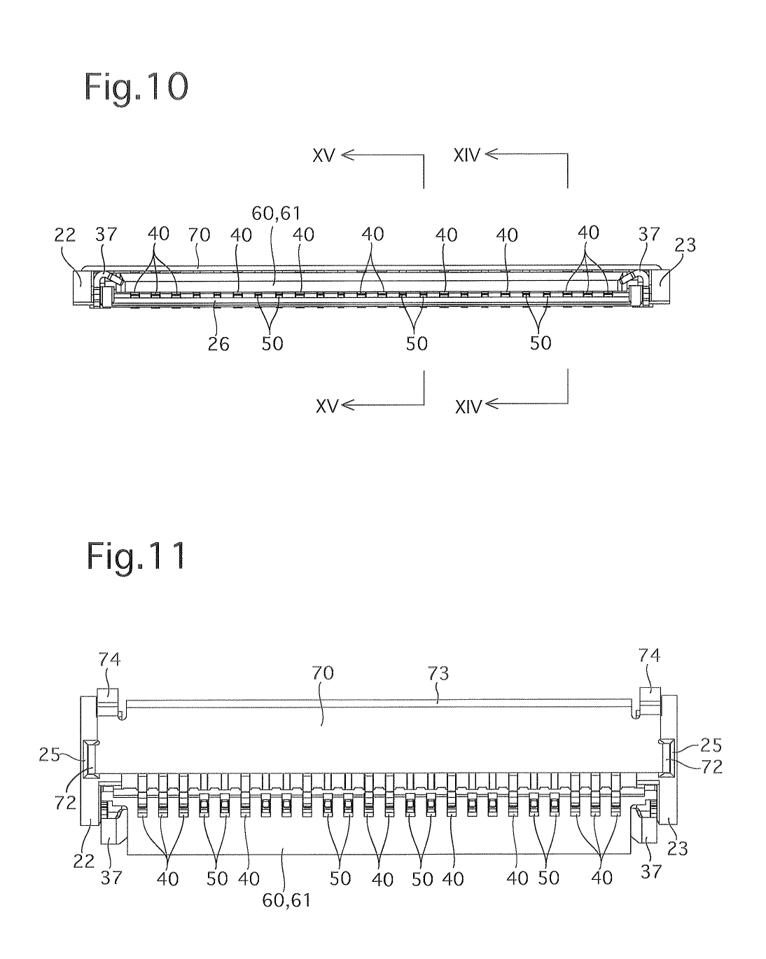

A first embodiment of a connector according to the present invention will be hereinafter discussed with reference to FIGS. 1 through 15. In the following descriptions, forward and rearward directions of the connector are determined with reference to the directions of the arrows shown in FIGS. 1 and 12 through 15.

The first embodiment of the connector 10 is for use in differential signaling. The connector 10 is provided with an insulator (electrical insulator/contact holder) 20, ground contacts 40, signal contacts 50, an actuator (rotatable actuator) 60 and a shell 70 which constitute relatively large elements of the connector 10.

The insulator 20 is made of electrical-insulative heat-resistant synthetic resin and formed by injection molding.

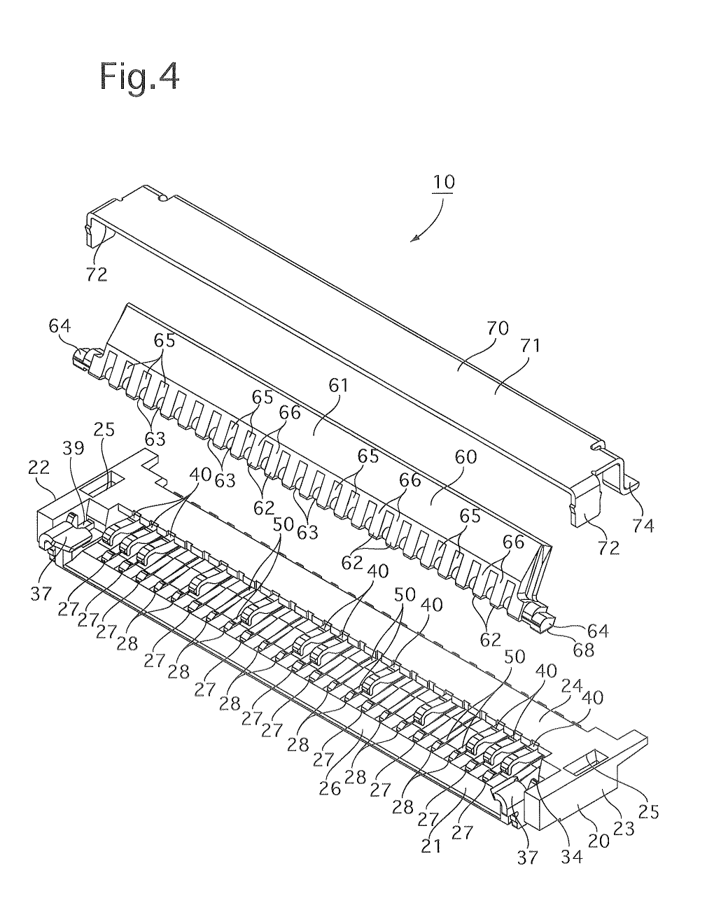

As shown in FIGS. 4 and 12 through 15, the insulator 20 is provided with a base plate 21, a left side wall 22, a right side wall 23 and a top wall 24. The base plate 21 extends in the rightward/leftward direction. The left side wall 22 and the right side wall 23 extend upward from the left and right side edges of the base plate 21, respectively. The top wall 24 connects rear halves of the top ends of the left side wall 22 and the right side wall 23.

The base plate 21 is provided at the front end thereof with an inclined surface 26 which slants down in the forward direction. The base plate 21 is provided on a top surface thereof with two types of grooves, i.e., first bottom-portion holding grooves 27 and second bottom-portion holding grooves 28, which are arranged at regular intervals and linearly extend parallel to one other in the forward/rearward direction from the rear end of the inclined surface 26 to the rear end of the base plate 21. The number of the two types of grooves 27 and 28 is 24 in total. The connector 10 is provided with a plurality of vertical partition walls 30 which connect the top wall 24 with rear ends of those portions of the base plate 21 which are positioned between adjacent grooves of the first and second bottom-portion holding grooves 27 and 28, so that the plurality of vertical partition walls 30 partition the adjacent grooves of the first and second bottom-portion holding grooves 27 and 28 at a rear end portion thereof. As shown in FIGS. 13 and 15, the top wall 24 is provided, on portions of the bottom surface thereof which face the rear ends of the second bottom-portion holding grooves 28, with holding projections 31 which project vertically downwards, down to positions above the second bottom-portion holding grooves 28, respectively. Each holding projection 31 is provided on a rear surface thereof with a recess 32 (see FIGS. 13 and 15) which is recessed forward (leftward as viewed in FIGS. 13 and 15).

The insulator 20 is provided on the inner parts of the left side walls 22 and the right side wall 23 with left and right engaging holes which extend rearward, and fitting lugs 38 of a pair of metal fittings 37 are fitted into the left and right engaging holes, respectively. Upper surfaces of front end portions of the fitting lugs 38 are formed to serve as horizontal flat support surfaces 39.

As shown in FIGS. 4, 5 and 12 through 15, the connector 10 is provided with twelve ground contacts 40 and twelve signal contacts 50 which are inserted into the spaces partitioned by the plurality of vertical partition walls 30 from the rear ends of the partitioned spaces. Both the ground contacts 40 and the signal contacts 50 are made of metal (conductive material).

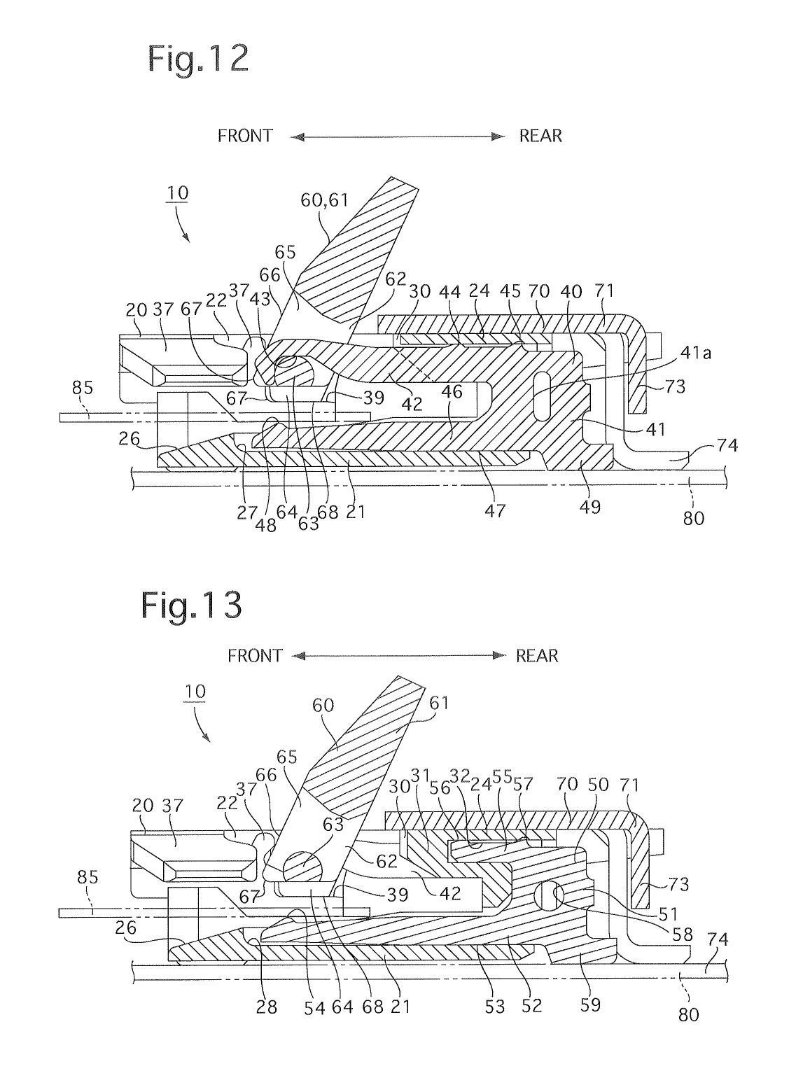

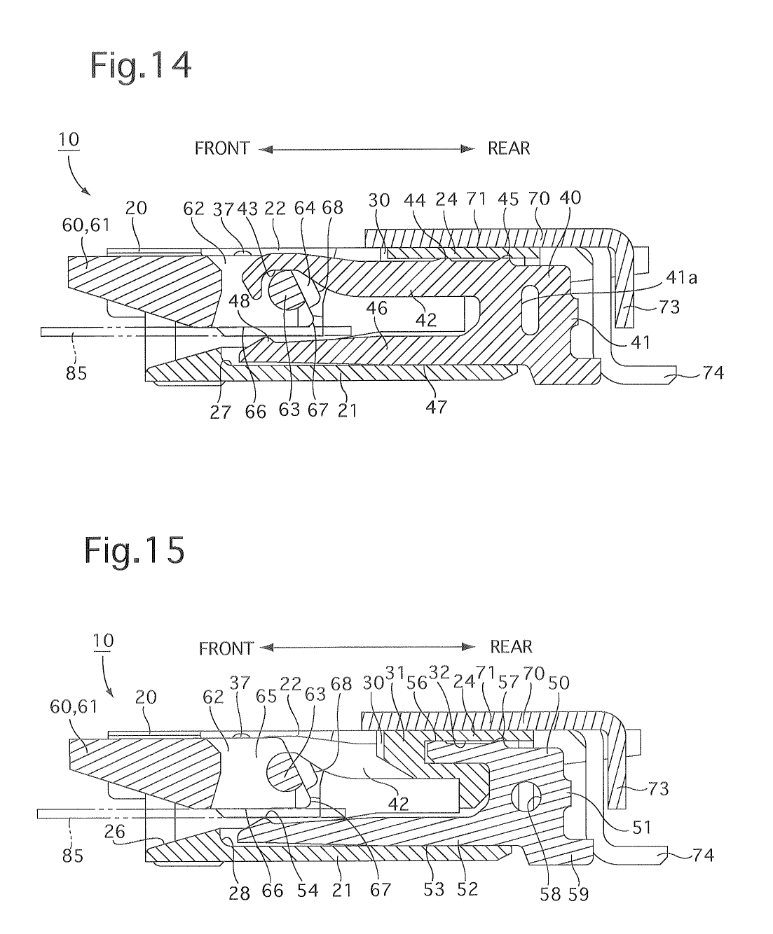

The ground contacts 40, which are electrical contacts inserted into the spaces in the insulator 20 which are respectively correspond to the first bottom-portion holding grooves 27, are each provided with a base portion 41, a holding arm 42, a contacting arm 46 and a hook-shaped conductive portion 49. The base portion 41 constitutes a rear end portion of the ground contact 40. The holding arm 42 and the contacting arm 46 extend forward from the base portion 41. The hook-shaped conductive portion 49 projects rearward from the lower end of the base portion 41 to be in electrically continuous conduction with a board 80 (see FIG. 12) to which the connector 10 is mounted. The ground contacts 40 are greater in thickness than the signal contacts 50. The base portion 41 of each ground contact 40 has an elongated through-hole 41a which is elongated vertically and formed through the base portion 41 in the direction of thickness of the ground contact 40. The holding arm 42 of each ground contact 40 is provided, on a lower surface thereof in the vicinity of the front end of the holding arm 42, with an engaging recess 43 which is recessed upward. The holding arm 42 of each ground contact 40 is provided, on an upper surface thereof in the vicinity of the fixed end (right end as viewed in FIGS. 12 and 14) of the holding arm 42, with a protrusion 44, and is further provided, on an upper surface of the base portion 41 behind the protrusion 44, with a protrusion 45. The protrusions 44 and 45 are in contact with a lower surface of the top wall 24. The rear half of the lower surface of the contacting arm 46 of each ground contact 40 constitutes a contacting flat surface 47 which is in surface contact with a flat bottom surface of the associated first bottom-portion holding groove 27, and front half of the lower surface of the contacting arm 46 of each ground contact 40 lies off the bottom surface of the associated first bottom-portion holding groove 27. Additionally, the contacting arm 46 is provided at the front end thereof with a contacting projection 48 which projects upward to be capable of contacting an associated conductive portion (not shown) formed on a lower surface of a flexible PWB (connection target) 85.

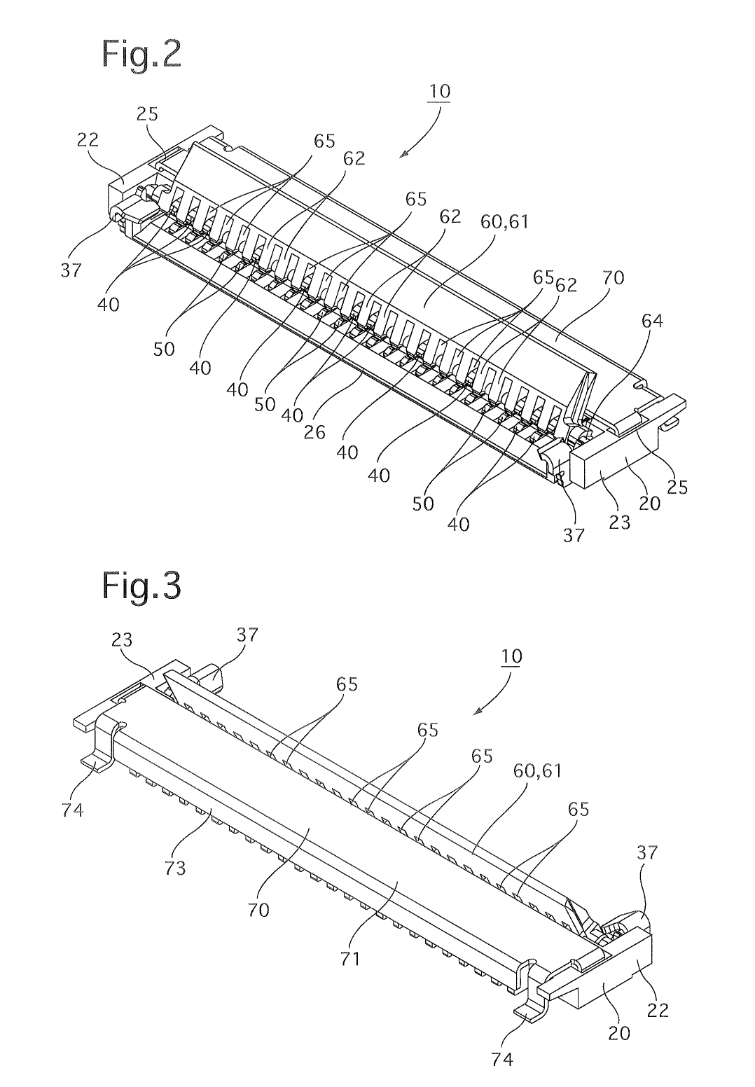

The signal contacts 50, which are electrical contacts inserted into the spaces in the insulator 20 which are respectively correspond to the second bottom-portion holding grooves 28, are arranged as pairs, each pair of which is positioned between two of the ground contacts 40 (right and left ground contacts 40) as shown in FIGS. 1 and 2.

Each signal contact 50 is provided with a base portion 51, a contacting arm 52, a locking portion 55 and a hook-shaped conductive portion 59. The base portion 51 constitutes a rear end portion of the signal contact 50. The contacting arm 52 and the locking portion 55 extend forward from the base portion 51. The hook-shaped conductive portion 59 projects rearward from the lower end of the base portion 51 to be in electrically continuous conduction with the board 80 (see FIG. 13). The rear half of the lower surface of the contacting arm 52 of each signal contact 50 constitutes a contacting flat surface 53 which is in surface contact with a flat bottom surface of the associated second bottom-portion holding groove 28, and front half of the lower surface of the contacting arm 46 of each ground contact 40 lies off the bottom surface of the associated second bottom-portion holding groove 28. The contacting arm 52 is provided at the front end thereof with a contacting projection 54 which projects upward to be capable of contacting an associated conductive portion (not shown) formed on a lower surface of the flexible PWB 85. As shown in the drawings, the locking portion 55 of each signal contact 50 is a portion thereof which is fitted into the recess 32 of the associated holding projection 31. The locking portion 55 and the base portion 51 of each signal contact 50 are provided on upper surfaces thereof with a protrusion 56 and a protrusion 57, respectively, which are in contact with a lower surface of the top wall 24. Additionally, the base portion 51 of each signal contact 50 has a circular through-hole 58 which is formed through the base portion 51 in the direction of thickness of the signal contact 50. The contacting arms 52 of the signal contacts 50 are level with the contacting arms 46 of the ground contacts 40. The positions of the contacting projections 48 that project from the contacting arms 46 of the ground contacts 40 and the positions of the contacting projections 54 that project from the contacting arms 52 of the signal contacts 50 in the forward/rearward direction are the same.

The actuator 60 is made of heat-resistant synthetic resin by injection molding. The actuator 60 is provided with an operating portion 61, a plurality of cam portions 62, a plurality of pressed portions (held portions) 63 and a pair of pivots (held portions) 64. The operating portion 61 extends in the rightward/leftward direction. The plurality of cam portions 62 are arranged at intervals in the rightward/leftward direction and extend downward from a lower surface of the operating portion 61. Each pressed portion 63 connects side surfaces of the two adjacent cam portions 62. The pair of pivots 64 project in opposite directions away from each other from the lower ends of the right and left sides of the actuator 60 to be coaxially with each other. The plurality of pressed portions 63 and the pair of pivots 64 are elements of a held portion of the actuator 60, and the pair of pivots 64 and each pressed portion 63 lie in a straight line. Through-holes 65 through which the holding arms 42 of the plurality of ground contacts 40 penetrate are formed in the actuator 60 so that each through-hole 65 is positioned to be surrounded by the operating portion 61, the two adjacent cam portions 62 and the pressed portion 63 positioned therebetween. The front surface of each cam portion 62 constitutes a flat pressing surface 66, and the lower front edge of the actuator 60 which is continuous with the flat pressing surface 66 of the cam portion 62 constitutes a cam surface 67 (see FIGS. 12 and 13). As shown in FIGS. 12 through 15, the lower end surfaces of the pair of pivots 64 are formed in flat surfaces serving as open-position holding surfaces 68.

As shown in FIG. 12, the open-position holding surfaces 68 of the pair of pivots 64, which are respectively positioned on the right and left ends of the actuator 60, are in contact with the flat support surfaces 39 of the pair of metal fittings 37, respectively, and the engaging recess 43 of the holding arm 42 of each ground contact 40 is engaged with the associated pressed portion 63 from above. According to this structure, the actuator 60 is rotatable about the pair of pivots 64 between the open position shown in FIGS. 12 and 13 and the closed position shown in FIGS. 14 and 15. When the actuator 60 is in the open position as shown in FIGS. 12 and 13, the open-position holding surfaces 68 of the pair of pivots 64 make surface contact with the flat support surfaces 39 of the pair of metal fittings 37, respectively, and accordingly, the actuator 60 is held in the open position unless an external force is exerted on the actuator 60.

The shell 70 covers the rear half of the insulator 20 and is made of metal. The shell 70 is provided with a top plate 71, a pair of connecting lugs 72, a rear wall 73 and a pair of connecting portions 74. The top plate 71 is formed as a flat plate. The pair of connecting lugs 72 project downward from the right and left edges of the top plate 71, respectively. The rear wall 73 extends downward from a rear edge of the top plate 71. Each connecting portion 74 has the shape of a substantially letter L as viewed from a side of the connecting portion 74, and the pair of connecting portions 74 are positioned on the laterally opposite sides of the rear wall 73 and extend downward from the right and left ends of the rear edge of the top plate 71, respectively.

The shell 70 is installed to rear half of the insulator 20 by engaging the pair of connecting lugs 72 into a pair of fixing holes 25 formed as recesses in the right and left ends of the top surface of the insulator 20, respectively. In a state where the shell 70 is installed onto the insulator 20, the top plate 71 covers the top wall 24 of the insulator 20, the rear wall 73 covers the rear ends of each ground contact 40 and each signal contact 50 (rear end of the insulator 20), and the pair of connecting portions 74 are fixed (soldered) to upper surfaces of the board 80.

In the connector 10 that has the above described structure, if the flexible PWB 85 is inserted into insulator 20 from the front end thereof with the actuator 60 in the open position as shown in FIGS. 12 and 13, the flexible PWB 85 is positioned between the holding arms 42 and the contacting arms 46 of the twelve ground contacts 40 and above the contacting arms 52 of the twelve signal contacts 50.

In this state shown in FIGS. 12 and 13, rotating the actuator 60 to the closed position as shown in FIGS. 14 and 15 causes the cam surface 67 of the actuator 60 to depress the flexible PWB 85 in the process of rotating before the actuator 60 reaches the closed position. Upon the actuator 60 reaching the closed position, the pressing surface 66 of the actuator 60 presses an upper surface of the flexible PWB 85 to depress the flexible PWB 85. Therefore, the contacting projections 48 of the ground contacts 40 and the contacting projections 54 of the signal contacts 50 make secure contact with the aforementioned conductive portions (not shown) on the lower surface of the flexible PWB 85 so as to be electrically connected therewith. Additionally, when the actuator 60 is in the closed position, the pressing surface 66 of the actuator 60 makes surface contact with an upper surface of the flexible PWB 85, and accordingly, the actuator 60 is held in the closed position unless an external force is exerted on the actuator 60.

In the above illustrated embodiment of the connector 10, since the elongated through-hole 41a is formed through the base portion 41 of each ground contact 40 and since the circular through-hole 58 is formed through the base portion 51 of each signal contact 50, the laterally-opposed surfaces of adjacent contacts of the ground contacts 40 and the signal contacts 50 are smaller in area than those in the case where no hole corresponding to the elongated through-hole 41a or the circular through-hole 58 is formed through either of each ground contact 40 or each signal contact 50. Therefore, the capacitance components of each ground contact 40 and each signal contact 50 of the above illustrated embodiment of the connector 10 have been reduced.

Moreover, although each ground contact 40 includes the holding arm 42 for pressing the associated pressed portion 63 of the actuator 60 from above, each signal contact 50 does not include any arm corresponding to the holding arm 42. Accordingly, the capacitance components of the signal contacts 50 in the above illustrated embodiment of the contact 10 have been reduced extensively compared with the case where each signal contact includes an arm corresponding to the holding arm 42.

Since the capacitance components which are a cause of crosstalk have been reduced in the above illustrated embodiment of the connector 10 in comparison with prior art, the connector 10 can deliver an excellent impedance matching capability. Moreover, since a reduction in capacitance component is achieved, the connector 10 makes a high-speed transmission possible.

In addition, the signal contacts 50 are resistant to external perturbations such as noise and induction since each signal contact 50 includes no arm corresponding to the holding arm 42 that each ground contact 40 has.

Additionally, the inductance components of the signal contacts 50 in the above illustrated embodiment of the contact 10 have also been reduced extensively compared with the case where each signal contact 50 includes an arm corresponding to the holding arm 42. Since the inductance components also contribute to a deterioration of the impedance matching capability, in this respect also, it can be said that the connector 10 can deliver an excellent impedance matching capability in comparison with prior art.

Additionally, the actuator 60 can be rotated with stability since the holding arm 42 of each ground contact 40 presses the associated pressed portion 63 of the actuator 60 from above.

Moreover, each ground contact 40 is superior in mechanical strength to each signal contact 50 since each ground contact 40 is greater in thickness (thickness in the right/left direction of the actuator 60) than each signal contact 50. Therefore, although only the ground contacts 40 (the holding arm 42 thereof) press the pressed portions 63 of the actuator 60 while the signal contacts 50 do not press any of the pressed portions 63 of the actuator 60, the actuator 60 can be rotated with reliability and stability.

Additionally, by making each ground contact 40 greater in thickness than each signal contact 50 in this manner, the distances between the laterally-opposed surfaces of the ground contacts 40 which are adjacent to the signal contacts 50 become short, which achieves a further improvement in impedance matching capability. Namely, since the distance between each central plane extending in the forward/rearward direction through each ground contact 40 and each signal contact 50 is equal, the distance between laterally-opposed surfaces of the ground contacts 40 which are adjacent to the signal contacts 50 become shorter than in the case where the thickness of each ground contact 40 is equal to that of each signal contact 50.

Additionally, since the base portion 41 of each ground contact 40 and the base portion 51 of each signal contact 50 are covered by the shell 70, the connector 10 has an excellent electromagnetic shielding characteristic (electromagnetic interference (EMI) characteristic).

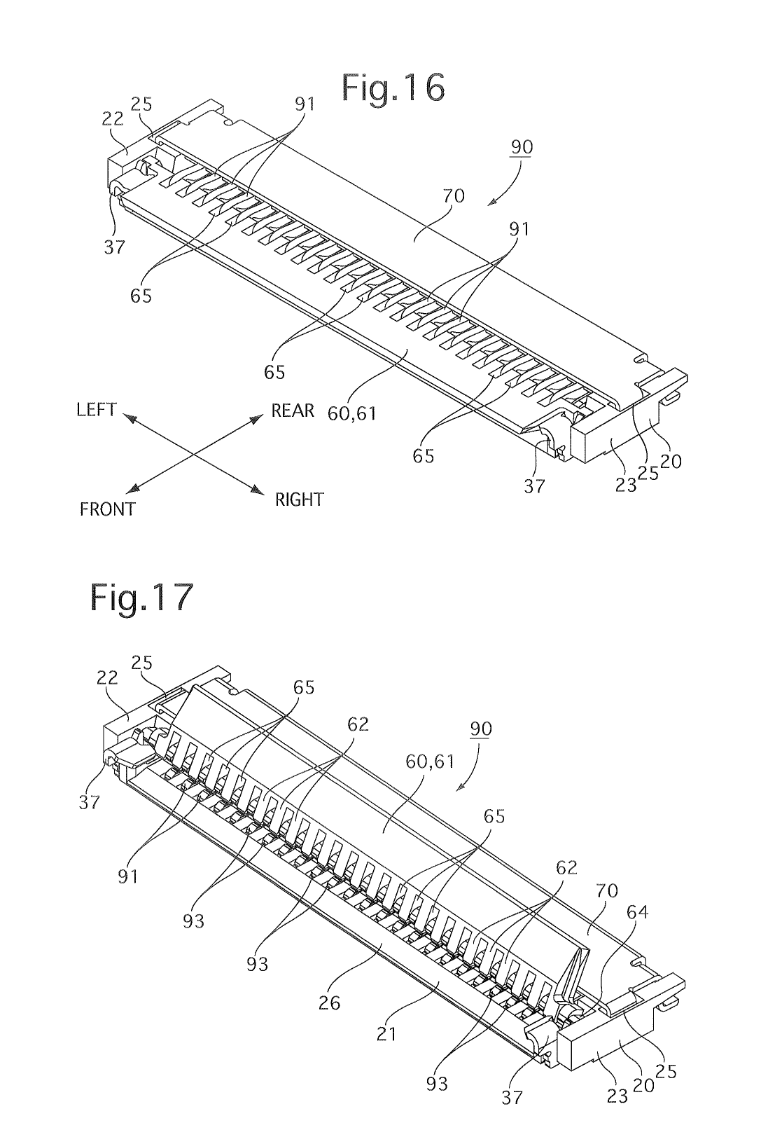

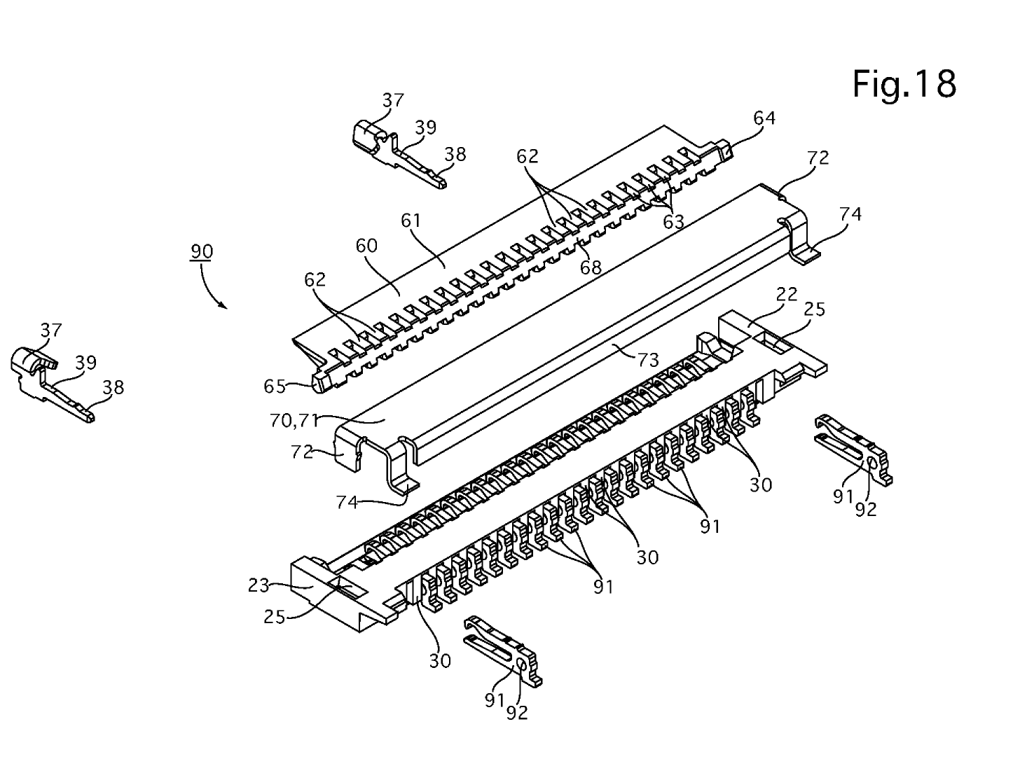

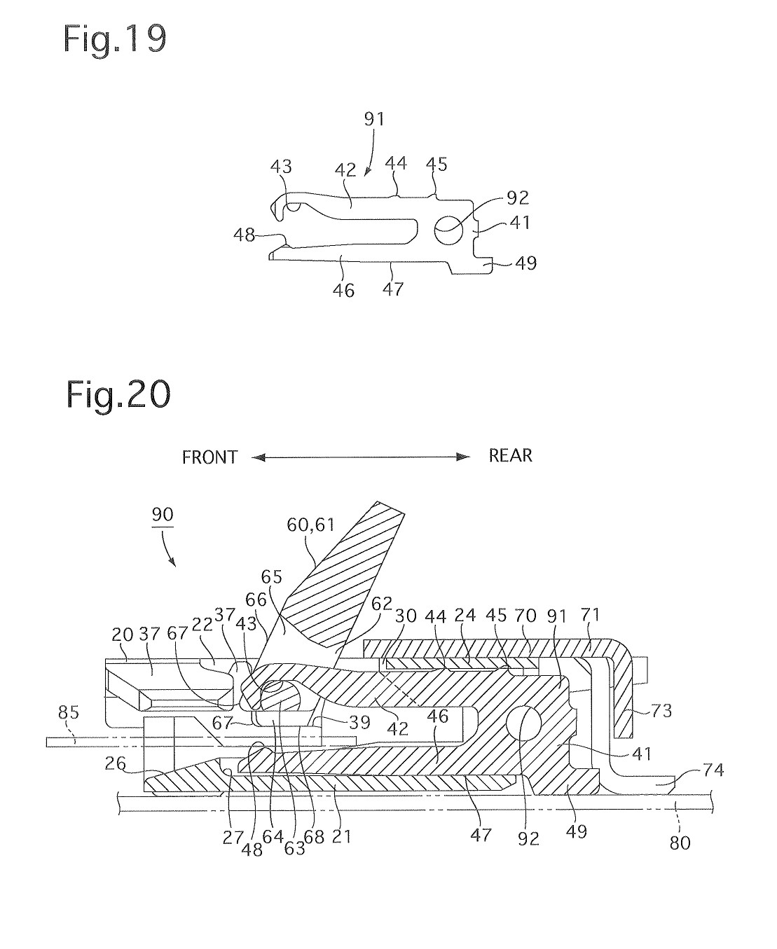

A second embodiment of the connector according to the present invention will be hereinafter discussed with reference to FIGS. 16 through 20. Elements of the second embodiment of the connector 90 which are similar to those of the above described first embodiment of the connector 10 are designated by the same reference numerals and the detailed descriptions of such elements are omitted from the following descriptions.

The basic structure of the connector 90 is the same as the basic structure of the connector 10; however, all the contacts 91 of the connector 90 are of the same kind. Each contact 91 is substantially identical in outward appearance to each ground contact 40; namely, each contact 91 is provided with a base portion 41, a holding arm 42, an engaging recess 43, a protrusion 44, a protrusion 45, a contacting arm 46, a contacting flat surface 47, a contacting projection 48 and a hook-shaped conductive portion 49, similar to each ground contact 40 of the first embodiment of the connector 10. However, the base portion 41 of each contact 91 is provided with a circular through-hole 92, unlike the base portion 41 of each ground contact 40 that is provided with the elongated through-hole 41a.

Since all the contacts of the connector 90 are of the same kind, the base plate 21 of the connector 90 is provided on top thereof with only bottom-portion holding grooves 93 of the same kind (see FIG. 17; twenty-four bottom-portion holding grooves 93 in total, the same as the total number of the first and second bottom-portion holding grooves 27 and 28) and the insulator 20 of the connector 90 does not have the holding projections 31 that the insulator 20 of the connector 10 has.

In the second embodiment of the connector 90 that has the above described structure, since the circular through-hole 92 is formed through the base portion 41 of each contact 91, the capacitance components of the contacts 91 is reduced compared to the case where the base portion 41 does not have the circular through-hole 92 formed therethrough.

Accordingly, similar to the first embodiment of the connector 10, the connector 90 can achieve an excellent impedance matching capability; moreover, the connector 90 makes a high-speed transmission possible.

Although the present invention has been described based on the above illustrated first and second embodiments of the connectors, the present invention is not limited solely to these embodiments; making various modifications to these embodiments is possible.

For instance, although differential signaling is carried out through each pair of signal contacts 50 that are positioned between the two ground contacts 40 on adjacent right and left sides of the pair of signal contacts 50 in the first embodiment of the connector, each signal contact 50 can be used as a contact for single-ended signaling. In addition, the number of signal contacts 50 between the two adjacent ground contacts 40 on the right and left sides thereof can be one, or the ground contacts 40 and the signal contacts 50 can be alternately arranged in the right/left direction of the connector.

Furthermore, the locking portion 55 can be omitted from each signal contact 50.

Additionally, each ground contact 40 and each signal contact 50 can be made to have the same thickness in the case where the distance between each central plane extending in the forward/rearward direction through each of the ground contacts 40 and the signal contacts 50 further becomes narrow.

Additionally, although the through-holes 65 of the actuator 60 are formed not only at positions corresponding to ground contacts 40 (the holding arms 42) but also at positions corresponding to the signal contacts 50, the through-holes 65 formed at positions corresponding to the signal contacts 50 are unnecessary, so that it is unnecessary to form these through-holes 65 in the actuator 60, which makes it possible to improve the strength of the actuator 60.

Additionally, the hook-shaped conductive portion 49 of each ground contact 40 can be grounded via the shell 70 (e.g., the rear wall 73 thereof).

In addition, in the first embodiment of the connector 10, it is possible that one and the other of each ground contact 40 and each signal contact 50 be inserted into the insulator 20 from the front and the rear thereof, respectively, and that the positions of the contacting projections 48 of the ground contacts 40 and the positions of the contacting projections 54 of the signal contacts 50 be shifted relative to one another in the forward/rearward direction.

Likewise, it is possible that half and the remaining half of all the contacts 91 be inserted into the insulator 20 from the front and the rear thereof, respectively, in the second embodiment of the connector 19.

The shapes of the through-holes (the elongated through-holes 41a and the circular through-holes 58) formed through the base portions 41 and 51 in the first and second embodiments of the connectors, respectively, are not limited solely to the shapes shown in the drawings; other shapes are possible. In addition, each of the elongated through-holes 41a and the circular through-holes 58 do not necessarily have to be a through-hole; a cutout portion which is open at the front, rear, upper or lower surface of the base portion 41 or 51 (and extending therethrough in the direction of thickness of the base portion 41 or 51) can be formed instead.

Furthermore, in the first embodiment of the connector, it is possible for the elongated through-hole 41a not to be formed through each ground contact 40.

Although all the contacts 91 can be used for signal transmission in the second embodiment of the connector, it is possible for some of the contacts 91 to be used as ground contacts without the circular through-hole 92 (or cutout portion) being formed through each of these ground contacts.

Additionally, in the first and second embodiments of the connectors, the actuator 60 can be provided with recesses instead of the through-holes 65, in which the front ends of the holding arms 42 of the plurality of ground contacts 40 are loosely fitted (however, such recesses need to have a sufficient depth allowing the actuator 60 to rotate from the open position to the closed position).

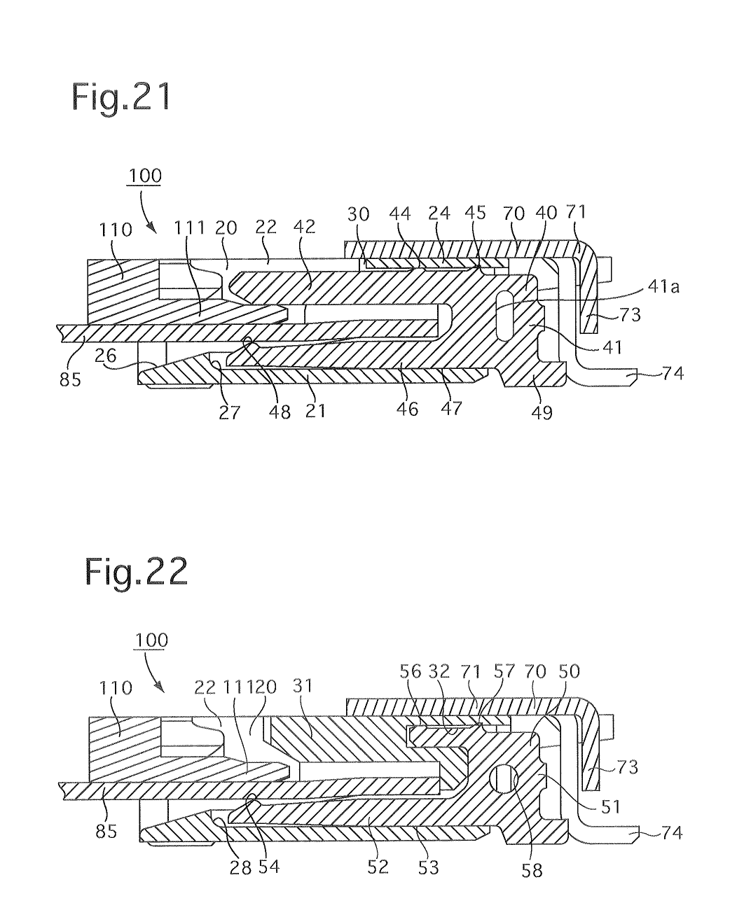

Alternatively, the rotatable actuator 60 can be replaced by a slidable actuator 110 as shown in FIGS. 21 through 23.

FIGS. 21 and 22 show a modified embodiment of the first embodiment of the connector, in which the rotatable actuator 60 in the first embodiment of the connector is replaced by the slidable actuator 110.

The connector 100 shown in FIGS. 21 and 22 is provided with an insulator 20, vertical partition walls 30 and holding projections 31 which are slightly different in shape from those of the first embodiment of the connector 10 but have the same functions as those of the first embodiment of the connector 10. The holding arm 42 of each ground contact 40 of the connector 100 is provided with no engaging recess corresponding to the engaging recess 43 formed on the holding arm 42 of each ground contact 40 of the first embodiment of the connector 10, so that the lower surface of the holding arm 42 of each ground contact 40 is flat. The connector 100 is provided with an actuator 110 instead of the actuator 60. The actuator 110 can be inserted into the insulator 20 from the front thereof. The actuator 110 is provided with a pressing portion 111 insertable in between the holding arms 42 and the contacting arms 46 of the ground contacts 40.

As shown in FIGS. 21 and 22, inserting the pressing portion 111 of the actuator 110 into the insulator 20 from the front thereof in a state where the rear end portion of the flexible PWB 85 (portion thereof shown in FIGS. 21 and 22) is positioned between the holding arms 42 and the contacting arms 46 of the twelve ground contacts 40 and above the contacting arms 52 of the twelve signal contacts 50 causes the pressing portion 111 to come into pressing contact with both the lower surface of the holding arm 42 of each ground contact 40 and the upper surface of the flexible PWB 85, thus causing the flexible PWB 85 to be pressed downward by the pressing portion 111 of the actuator 110. Consequently, the contacting projections 48 of the ground contacts 40 and the contacting projections 54 of the signal contacts 50 are electrically connected with the aforementioned conductive portions (not shown) on the lower surface of the flexible PWB 85 with reliability.

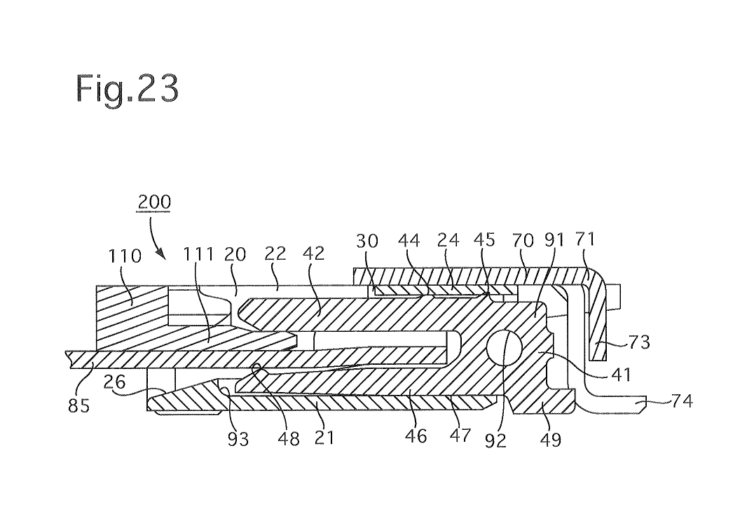

FIG. 23 shows a modified embodiment of the second embodiment of the connector, in which the rotatable actuator 60 in the second embodiment of the connector 90 is replaced by the slidable actuator 110.

The basic structure of the connector 200 shown in FIG. 23 is the same as the basic structure of the connector 100 shown in FIGS. 21 and 22; however, the insulator 20 of the connector 200 does not have the holding projections 31 that the insulator 20 of the connector 100 has, and is provided with bottom-portion holding grooves 93 instead of the first and second bottom-portion holding grooves 27 and 28. Inserting the pressing portion 111 of the actuator 110 into the insulator 20 causes the pressing portion 111 to come into pressing contact with both the lower surface of the holding arm 42 of each contact 91 and the upper surface of the flexible PWB 85. Consequently, the contacting projections 48 of the contacts 91 are electrically connected with the aforementioned conductive portions (not shown) on the lower surface of the flexible PWB 85 with reliability.

In this manner, effects similar to those obtained in each of the first and second embodiments of the connectors can also be obtained in the modified embodiment of the second embodiment of the connector shown in FIG. 23.

Although not shown in the drawings, the above described embodiments of the connectors can be modified so that the contacts (the ground contacts 40, the signal contacts 50 and the contacts 91) come in contact with (and in be in electrically continuous conduction with) conductive portions on the upper surface of the flexible PWB 85 even in the case of adopting either the rotatable type of actuator 60 or the slidable type of actuator 110.

Furthermore, in the first and second embodiments of the connectors, the capacitance component can be reduced if only at least one of the contacts (40, 50 or 91) of the connector is provided with a through-hole or a cutout portion (recessed portion), and accordingly, unlike the above illustrated embodiments of the connectors, not all the contacts (40, 50 or 91) need to be provided with a through-hole or a cutout portion.

In addition, although the shape, size and/or position of the through-holes (or cutout portions) formed through the contacts (40, 50 or 91) in each embodiment or modified embodiment are identical to each other, the shape, size and/or position of these through-holes (or cutout portions) can be changed for each contact in order to facilitate impedance matching.

Additionally, the connection target to be electrically connected to the connector can be a connection target other than a flexible PWB such as a flexible flat cable (FFC).

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A connector comprising:
an electrical insulator made of an insulating material;
a plurality of contacts fixed to said electrical insulator aligned in one direction, each of said plurality of contacts including a contacting arm which can be in electrically continuous conduction with one of front and rear surfaces of a connection target, and a base portion from which said contacting arm extends to support said contacting arm; and
an actuator which presses against the other of said front and rear surfaces of said connection target,
wherein at least one of said plurality of contacts includes a holding arm which extends from said base portion in a direction substantially parallel to said contacting arm to press said actuator toward said connection target, and
wherein one of a through-hole and a cutout portion is formed in at least one of said plurality of contacts through said base portion thereof in a thickness direction thereof.

2. The connector according to claim 1, wherein said one of said through-hole and said cutout portion is formed through at least one of said plurality of contacts which is used as a signal transmission line.

3. The connector according to claim 1, wherein said actuator is rotatable relative to said electrical insulator,
wherein said actuator comprises at least one held portion, and
wherein said actuator is rotatable about said held portion with said holding arm pressing against said held portion toward said connection target.

4. The connector according to claim 1, wherein said plurality of contacts comprise:
a plurality of ground contacts; and
a plurality of signal contacts fixed to said electrical insulator and positioned in between said plurality of ground contacts.

5. The connector according to claim 4, wherein, among said plurality of ground contacts and said plurality of signal contacts, only each of said ground contacts comprises said holding arm.

6. The connector according to claim 4, wherein a pair of said signal contacts are positioned between two of said ground contacts.

7. The connector according to claim 4, wherein said plurality of ground contacts and said plurality of signal contacts are alternately arranged in said one direction.

8. The connector according to claim 1, wherein said plurality of contacts are of the same kind each of which includes said holding arm.

9. The connector according to claim 1, wherein said connection target comprises an flexible PWB.

10. The connector according to claim 1, wherein said actuator is an elongated member which is elongated in said one direction.

11. The connector according to claim 10, wherein said actuator comprises a pair of pivots fixed at opposite ends of said elongated member in said one direction to be capable of rotating about said pair of pivots relative to said electrical insulator.

12. A connector comprising:
a contact holder made of an electrical insulating material;
a plurality of contacts fixed to said contact holder aligned in one direction, wherein each of said plurality of contacts includes a base portion and a contacting arm which extends from said base portion; and
an actuator which is moved relative to said contact holder to press one of front and rear surfaces of a connection target toward said contacting arm so that the other of said front and rear surfaces of said connection target is pressed against said contacting arm to be electrically connected therewith,
wherein at least one of said plurality of contacts includes a holding arm which extends from said base portion in a direction substantially parallel to said contacting arm to press said actuator toward said connection target, and
wherein one of a through-hole and a cutout portion is formed in at least one of said plurality of contacts through said base portion thereof in a thickness direction thereof.
